(19) United States
(12) Patent Application Publication
(10) Pub. No.: US 2013/0058097 A1
(43) Pub. Date: Mar. 7, 2013

(54) ADAPTIVE LIGHT-EMITTING-DIODE LIGHTING STRUCTURE

(71) Applicants: Ding-Hua Kuo, New Taipei City (TW); Wen-Ji Lan, New Taipei City (TW)

(72) Inventors: Ding-Hua Kuo, New Taipei City (TW); Wen-Ji Lan, New Taipei City (TW)

(21) Appl. No.: 13/225,934

(22) Filed: Sep. 6, 2011

(51) Int. Cl. F21V 29/00; F21V 21/00

(52) U.S. Cl. 362/294; 362/382

(57) ABSTRACT

An adaptive light-emitting-diode (LED) lighting structure includes a heat-dissipating element, at least one flexible support, a base, and an LED module. The heat-dissipating element has a first main body, and a heat-dissipating section and an electrically conductive section located at two opposite ends of the first main body. The base has a connecting face and an opposite heat-conducting face connected to the first main body. The flexible support includes a fixing section connected to the connecting face of the base, an extension section, and an LED holding section located at an end of the extension section opposite to the fixing section for holding the LED module thereon. The flexible support can be bent due to gravity force or an external force applied thereto by a user, so as to orient light from the LED module to different illuminating directions or areas, making the LED lighting structure very convenient for use.

### FIELD OF THE INVENTION

The present invention relates to an adaptive light-emitting-diode (LED) lighting structure, and more particularly to an adaptive LED lighting structure that includes at least one flexible support for connecting a light-emitting element to a base of a lamp, and the flexible support is bendable due to gravity force or a user-applied force to thereby orient light from the light-emitting element to different illuminating directions and areas.

### BACKGROUND OF THE INVENTION

Due to the constant developments in various technological fields, the conventional incandescent bulb lamps are quickly replaced by light-emitting-diode (LED) lamps. Due to its many advantages, including small volume, low power consumption, high lighting efficiency, long service life and mercury-free, LED has now been considered as the first choice for a lighting device in many applications. Currently, there are various differently designed and shaped illuminating devices available in the market, including various bulb lamps. Bulb lamps can be generally divided into two categories, namely, tungsten bulb lamps and LED bulb lamps. Herein, LED bulb lamps are discussed.

FIG. 1 is an exploded perspective view of a conventional bulb lamp using LEDs as a light source thereof. As shown, the illustrated conventional LED bulb lamp includes a lamp shade 10, a lamp base 11, a circuit board 12, and a plurality of LED bulbs 13. The lamp base 11 includes a first main body 111 and a heat-dissipating section 112, and an electrically conductive section 113.

The heat-dissipating section 112 is located around an outer side of the first main body 111, and the electrically conductive section 113 is located at an end of the first main body and connected to the heat-dissipating section 112. The circuit board 12 is vertically inserted in an end of the first main body 111 opposite to the electrically conductive section 113. The LED bulbs 13 are mounted on one side of the circuit board 12.

The LED bulb 13 emits directional light beams and provides lighting directions covering a substantially hemispherical area. Further, the LED bulb 13 has an illuminating angle about 20 degrees. Therefore, light beams forwardly emitted from the LED bulb 13 have the highest intensity while light beams sidewardly emitted therefrom are weaker in intensity compared with the forward light beams. Since the circuit board 12 in the currently available LED bulb lamp is vertically fixedly inserted in the first main body 111, it is not able to freely change the lighting directions of the LED bulb 13 once the LED bulb lamp is installed at a fixed position. That is, the light beams from an LED bulb lamp installed at a fixed position are always projected to the same directions, which could not be adjusted according to actual requirements. Therefore, the conventional LED bulb lamp has low flexibility in use and accordingly, limited applicability.

In brief, the conventional LED bulb lamp, once installed, has the following disadvantages: (1) having a fixed and unchangeable illuminating direction; (2) having limited applicability; and (3) causing confusion and inconvenience to users.

### SUMMARY OF THE INVENTION

A primary object of the present invention is to provide an adaptive LED lighting structure, illuminating directions and illuminating areas of which can be adjusted through gravity force or an external force applied thereto by a user.

To achieve the above and other objects, the adaptive LED lighting structure according to the present invention includes a heat-dissipating element, at least one flexible support, a base, and an LED module. The heat-dissipating element has a first main body, a heat-dissipating section, and an electrically conductive section located at an end of the first main body. The base is connected to the first main body and has a heat-conducing section, a heat-conducting face, and a connecting face. The flexible support includes a fixing section connected to the connecting face of the base, an extension section, and an LED holding section located at an end of the extension section opposite to the fixing section for holding the LED module thereon. The LED module includes a circuit board and at least one LED bulb fixedly mounted to one side of the circuit board.

The flexible support can naturally bend downward due to gravity force to orient light beams from the LED module to a floor, or can be bent by an external force applied thereto by a user to orient light beams from the LED module to different illuminating directions or areas according to actual need, making the adaptive LED lighting structure of the present invention highly convenient for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional LED bulb lamp;

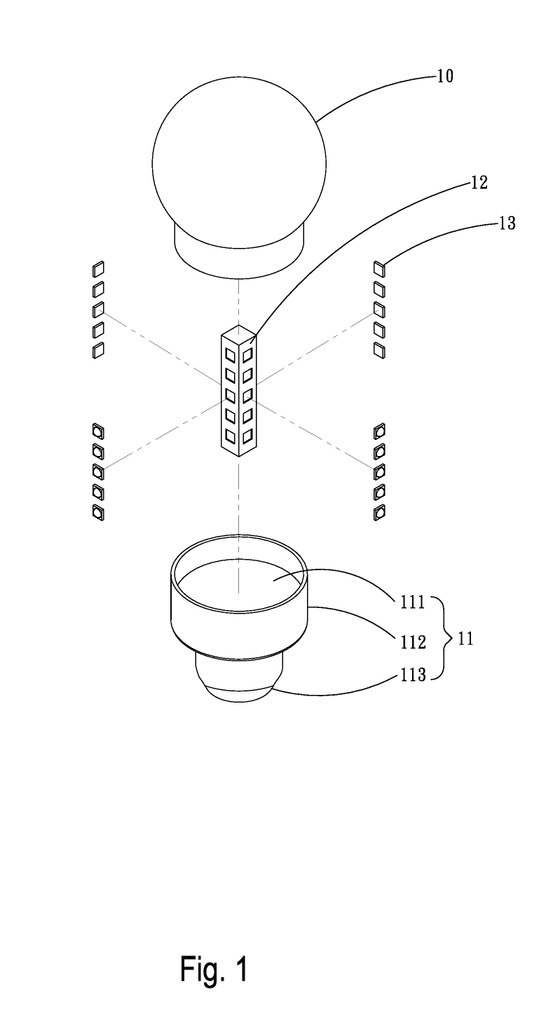

FIG. 2A is an exploded perspective view of an adaptive LED lighting structure according a first embodiment of the present invention;

FIG. 2B is an assembled view of FIG. 2A;

FIG. 3 is an assembled perspective view of an adaptive LED lighting structure according to a second embodiment of the present invention;

FIG. 4A is an exploded perspective view of an adaptive LED lighting structure according a third embodiment of the present invention;

FIG. 4B is an assembled view of FIG. 4A;

FIG. 5A is a side view showing an adaptive LED lighting structure according to a fourth embodiment of the present invention being used in a first manner;

FIG. 5B is a perspective view showing the adaptive LED lighting structure according to the fourth embodiment of the present invention being used in a second manner;

FIG. 6 is a perspective view showing an adaptive LED lighting structure according to a fifth embodiment of the present invention in use;

FIG. 7A is an assembled perspective view of an adaptive LED lighting structure according to a sixth embodiment of the present invention; and

FIG. 7B is another assembled perspective view of the adaptive LED lighting structure according to the sixth embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

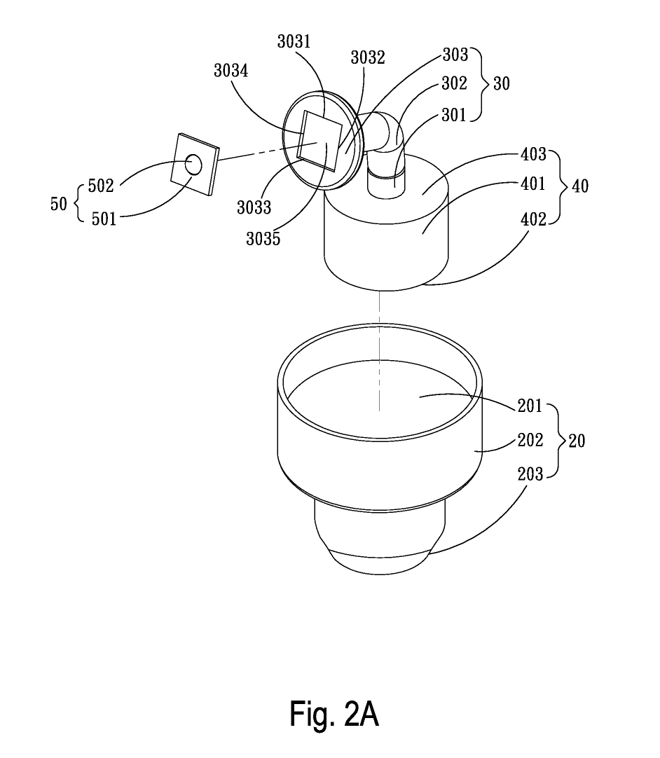

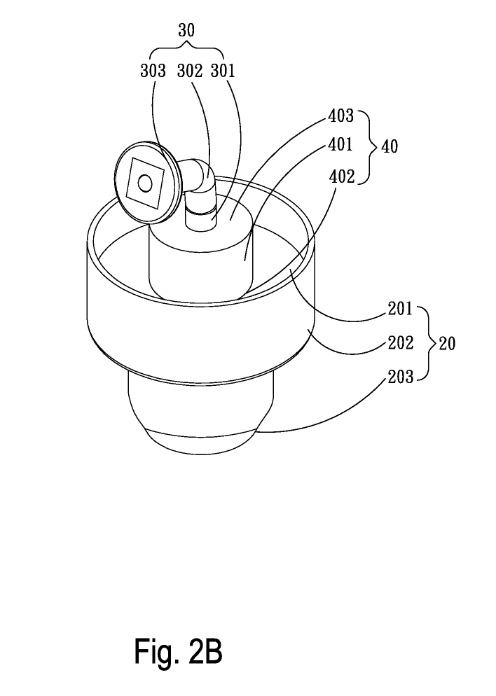

Please refer to FIGS. 2A and 2B that are exploded and assembled perspective views, respectively, of an adaptive LED lighting structure according to a first embodiment of the present invention. As shown, the adaptive LED lighting structure in the first embodiment includes a heat-dissipating element 20, at least one flexible support 30, a base 40, and an LED module 50.

The heat-dissipating element 20 includes a first main body 201, a heat-dissipating section 202, and an electrically conductive section 203. The electrically conductive section 203 is located at an end of the first main body 201.

The flexible support 30 includes a fixing section 301, an extension section 302, and an LED holding section 303 extended from an end of the extension section 302 opposite to the fixing section 301.

The base 40 includes a heat-conducting section 401, a heat-conducting face 402, and a connecting face 403. The heat-conducting face 402 is located at an end of the heat-conducting section 401 to connect to the first main body 201 of the heat-dissipating element 20; and the connecting face 403 is located at another end of the heat-conducting section 401 opposite to the heat-conducting face 402. The fixing section 301 of the flexible support 30 is connected to the connecting face 403 of the base 40.

The flexible support 30 can be made of a rubber material, a plastic material, or a metal material.

On the LED holding section 303, there is a receiving space 3035 enclosed in a first side 3031, a second side 3032, a third side 3033 and a fourth side 3034, which are defined on the LED holding section 303 at predetermined positions and sequentially connected to one another. The receiving space 3035 can be rectangular or round in shape, or can be in any other geometrical shapes. In the illustrated first embodiment, the receiving space 3035 is rectangular in shape without being limited thereto.

The LED module 50 is fitted in the receiving space 3035 on the LED holding section 303, and includes a circuit board 501 and at least one LED bulb 502. The LED bulb 502 is fixedly mounted to one side of the circuit board 501.

The fixing section 301, the extension section 302 and the LED holding section 303 of the flexible support 30 all are flexible. When the adaptive LED lighting structure is differently mounted so that gravity force acts on another different position thereof, all the flexible fixing section 301, the extension section 302 and the LED holding section 303 will naturally bend toward a direction from where the gravity force acts on the adaptive LED lighting structure. That is, light beams emitted from the LED module 50, which is mounted on the LED holding section 303, can be oriented to different directions instead of being always projected forwardly. With these arrangements, the adaptive LED lighting structure of the present invention has good applicability for use in different illuminating environmental conditions.

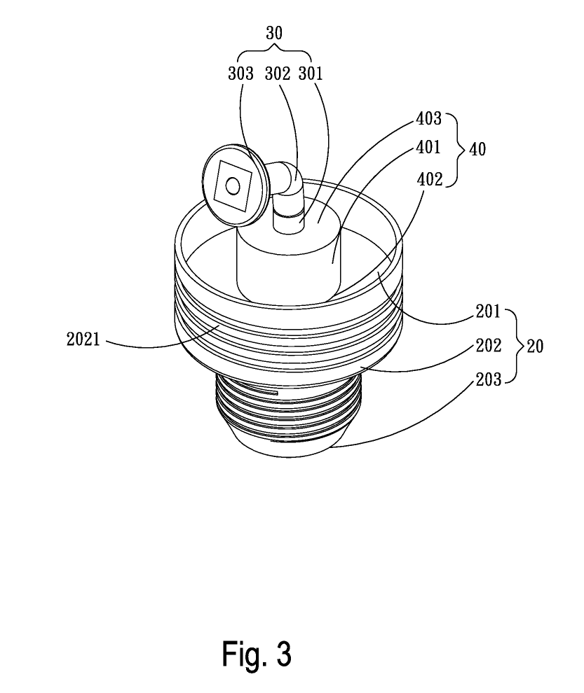

FIG. 3 is an assembled perspective view of an adaptive LED lighting structure according to a second embodiment of the present invention. As shown, the second embodiment is generally structurally similar to the first embodiment, except that the heat-dissipating section 202 of the heat-dissipating element 20 has a plurality of screw threads 2021 provided thereon to extend around an outer side of the first main body 201.

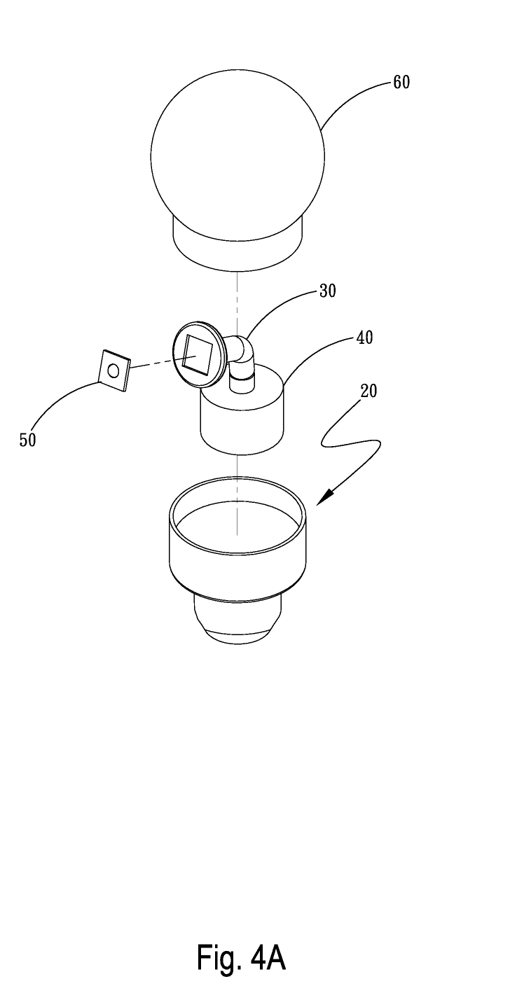

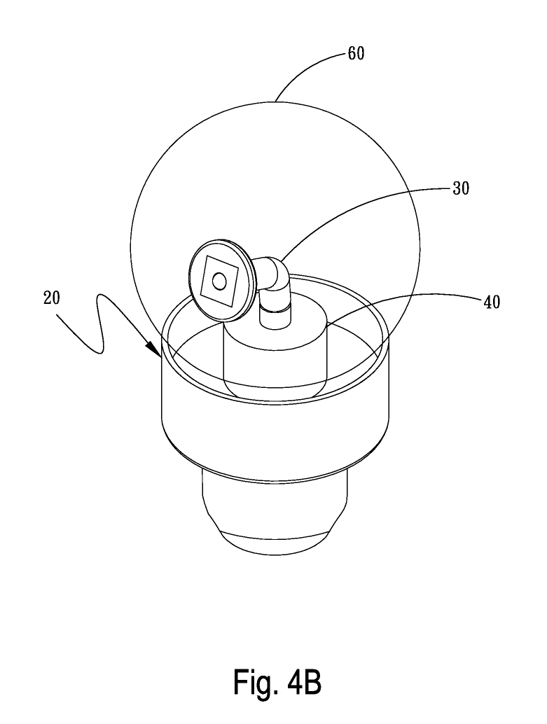

Please refer to FIGS. 4A and 4B that are exploded and assembled perspective views, respectively, of an adaptive LED lighting structure according to a third embodiment of the present invention. As shown, the third embodiment is generally structurally similar to the first embodiment, except for a lamp shade 60 that is connected to the heat-dissipating element 20 to enclose the flexible support 30, the base 40 and the LED module 50 therein. By providing the lamp shade 60, the flexible support 30, the base 40 and the LED module 50 are protected against damage to thereby enable extended service life of the adaptive LED lighting structure.

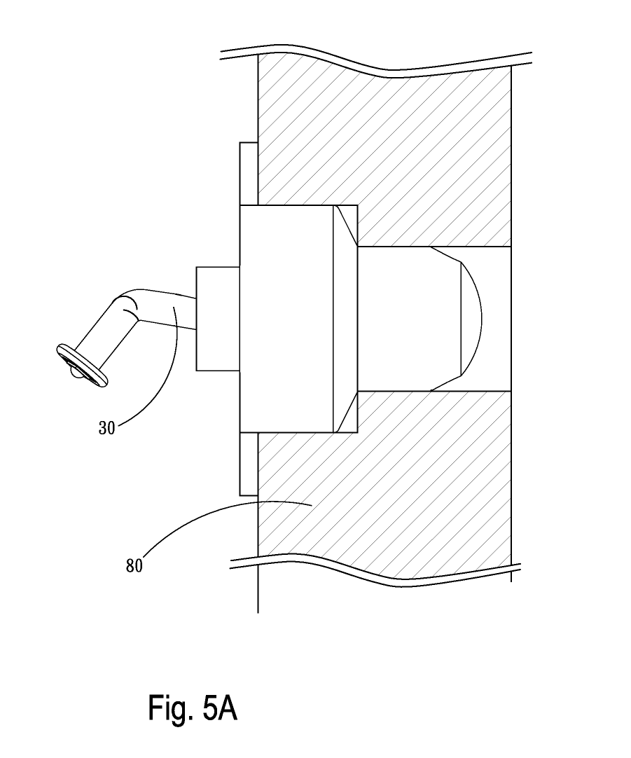

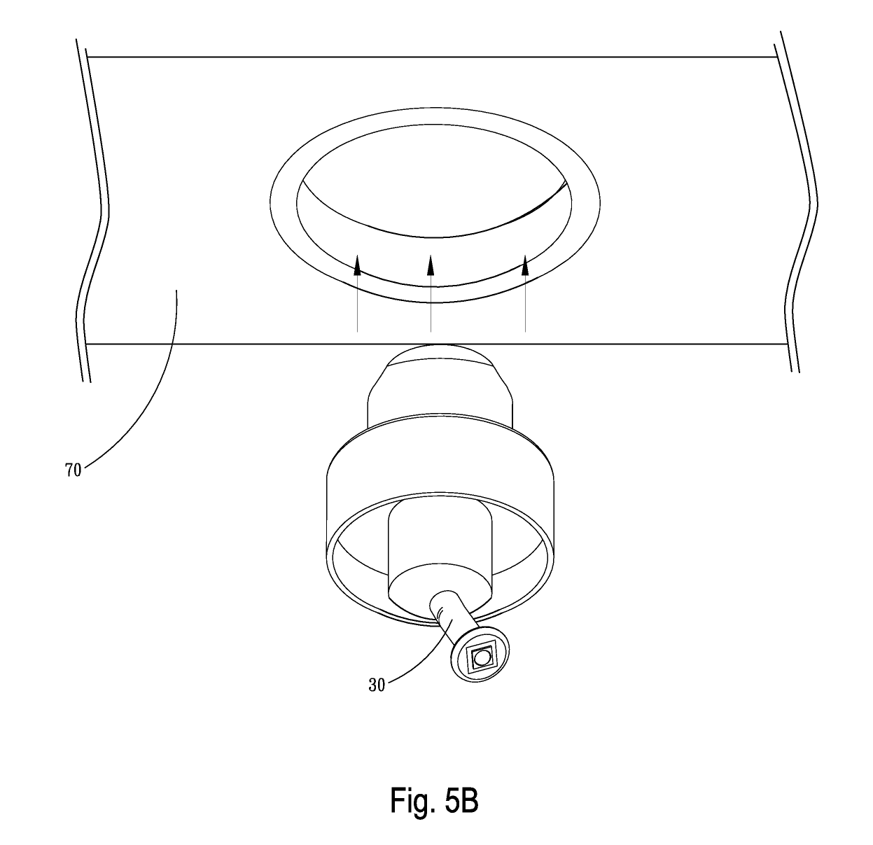

FIGS. 5A and 5B show an adaptive LED lighting structure according to a fourth embodiment of the present invention being mounted on a wall 80 and a ceiling 70, respectively. As shown in FIG. 5A, when the adaptive LED lighting structure in the fourth embodiment is mounted on a wall 80, the flexible support 30 naturally gradually bends downward due to the gravity force, so that light beams from the LED module 50 no longer project forward to parallel a floor but are oriented toward the floor. Therefore, the adaptive LED lighting structure of the present invention provides good applicability and a user can be freely mount it to a ceiling 70, a wall 80 or any other position to illuminate desired places or areas without the need of using other or additional lighting structures.

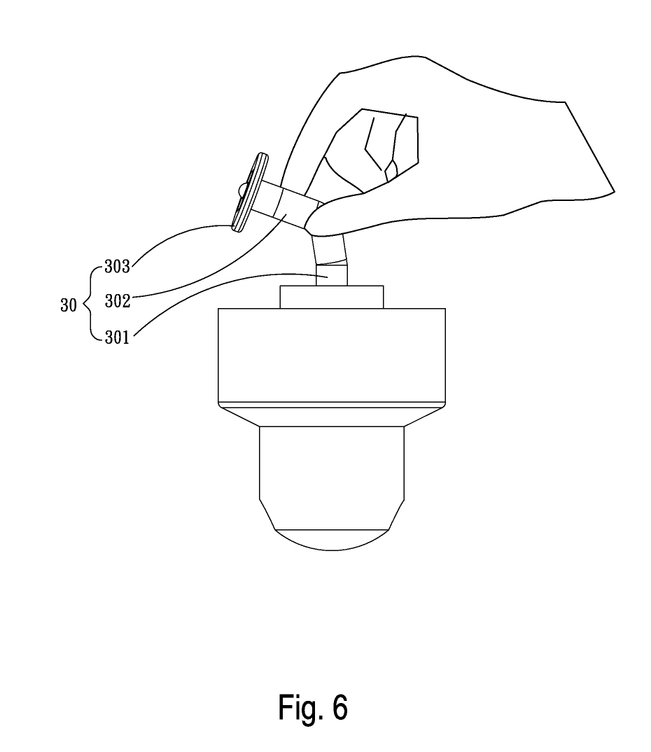

FIG. 6 is a perspective view showing an adaptive LED lighting structure according to a fifth embodiment of the present invention in use. As shown, the fifth embodiment is generally structurally similar to the first embodiment, except that the flexible support 30 in the fifth embodiment can be bent by an external force applied thereto. With this arrangement, a user can directly bend the flexible support 30 to orient the LED module on the flexible support 30 to any desired directions and thereby changes the illuminating directions of the LED lighting structure according to actual need. With this arrangement, the adaptive LED lighting structure of the present invention can have further increased applicability and is more convenient for use.

In brief, since the fixing section 301, the extension section 302 and the LED holding section 303 of the flexible support 30 all are flexible, the adaptive LED lighting structure of the present invention can provide variable illuminating direction and increased applicability to overcome the confusion and inconvenience brought to users by the conventional LED bulb lamps that have only one fixed illuminating direction.

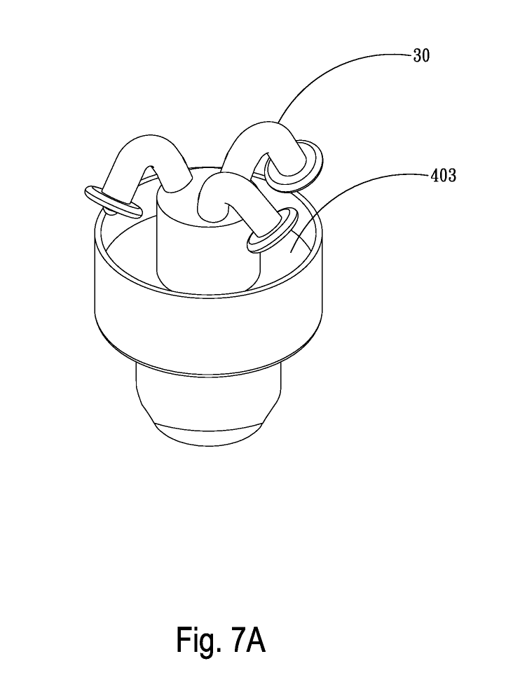

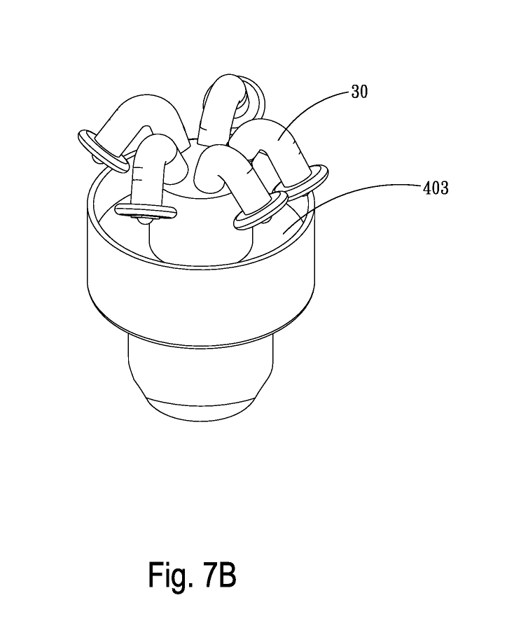

Please refer to FIGS. 7A and 7B that are two assembled perspective views of an adaptive LED lighting structure according to a sixth embodiment of the present invention. As shown, the sixth embodiment is generally structurally similar to the first embodiment, except that more than one flexible support 30 is connected to the connecting face 403 of the base 40. The number of the flexible supports 30 connected to the connecting face 403 is changeable according to a user's need. In the case the use prefers to a darker light source, the number of the flexible supports 30 can be decreased, as shown in FIG. 7A, so that the adaptive LED lighting structure provides a less bright light source. On the other hand, when the user prefers to a brighter light source, the number of the flexible supports 30 can be increased, as shown in FIG. 7B, so that the adaptive LED lighting structure provides a brighter light source. In brief, the brightness of the adaptive LED lighting structure can be adjusted by changing the number of the flexile supports 30 on the connecting face 403.

Therefore, the present invention is superior to the conventional LED bulb lamps in that (1) it provides variable illuminating direction; (2) it has increased applicability; and (3) it is convenient for use to thereby reduce user's confusion and inconvenience in mounting different or additional LED lamps with fixed illuminating direction.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An adaptive LED lighting structure, comprising:
a heat-dissipating element having a first main body, a heat-dissipating section, and an electrically conductive section; and the electrically conductive section being located at an end of the first main body;
a base being connected to the first main body, and having a heat-conducting section, a heat-conducting face, and a connecting face;
at least one flexible support having a fixing section, an extension section, and an LED holding section extended from an end of the extension section opposite to the fixing section; and the fixing section being connected to the connecting face of the base; and
an LED module being mounted on the LED holding section of the flexible support and including a circuit board and at least one LED bulb; and the at least one LED bulb being fixedly mounted to one side of the circuit board.

2. The adaptive LED lighting structure as claimed in claim 1, wherein the LED holding section is provided with a receiving space enclosed in a first side, a second side, a third side and a fourth side, which are defined on the LED

3. The adaptive LED lighting structure as claimed in claim 1, wherein the heat-dissipating section of the heat-dissipating element has a plurality of screw threads provided thereon to extend around an outer side of the first main body.

4. The adaptive LED lighting structure as claimed in claim 1, wherein the heat-conducting face is located at an end of the base to connect to the first main body of the heat-dissipating element; and the connecting face is located at another end of the base opposite to the heat-conducting face to connect to the fixing section of the flexible support.

5. The adaptive LED lighting structure as claimed in claim 2, wherein the LED module is fitted in the receiving space on the LED holding section.

6. The adaptive LED lighting structure as claimed in claim 2, wherein the receiving space on the LED holding section is rectangular in shape.

7. The adaptive LED lighting structure as claimed in claim 2, wherein the receiving space on the LED holding section has a shape selected from the group consisting of a round shape and any other geometrical shapes.

8. The adaptive LED lighting structure as claimed in claim 1, further comprising a lamp shade connected to the heat-dissipating element to enclose the flexible support, the base and the LED module therein.

9. The adaptive LED lighting structure as claimed in claim 1, wherein the flexible support is made of a material selected from the group consisting of a rubber material, a plastic material, and a metal material.
